(19) United States
(12) Patent Application Publication
(10) Pub. No.: US 2025/0108660 A1
(43) Pub. Date: Apr. 3, 2025

(54) BICYCLE HUB KIT

(71) Applicant: Wei-Yueh CHANG, Taichung City (TW)

(72) Inventor: Wei-Yueh CHANG, Taichung City (TW)

(21) Appl. No.: 18/476,941

(22) Filed: Sep. 28, 2023

(51) Int. Cl. B60B 27/00; B60B 27/02; B60B 27/04; F16D 41/24

(52) U.S. Cl. CPC B60B 27/0057; B60B 27/023; B60B 27/04; F16D 41/24

(57) ABSTRACT

A bicycle hub kit has a shaft, a hub body surrounding the shaft, a driver disposed to a first end of the hub body, a connecting arm disposed to a second end of the hub body, a clutch sleeve disposed inside the hub body, a braking base surrounding and fixed to the shaft, a spring set disposed between the clutch sleeve and the braking base, at least one brake pad disposed between an internal peripheral surface of the hub body and outer peripheries of the clutch sleeve and the braking base. The clutch sleeve has a disengagement segment and a braking segment connected to the driver via a threaded engagement. A sprocket connected to the driver can be alternated between a braking sprocket and a one-way sprocket to transform the bicycle hub kit to be with or without function of a coaster brake.

### BACKGROUND OF THE INVENTION

### 1. Field of the Invention

The present invention relates to a bicycle kit, and more particularly to a bicycle hub kit that has a replaceable sprocket to transform the bicycle hub kit to be with or without function of a coaster brake.

### 2. Description of Related Art

A bicycle hub kit is a transmission component of a bicycle, is disposed to a center of a rear wheel, surrounds a shaft, and is connected to spokes. When pedals are stamped forwardly, the bicycle hub kit is driven via a chain driving device to drive the rear wheel to rotate forwardly, thereby driving the bicycle forward. Conventional bicycle hub kits may include a hub kit without function of a coaster brake and a hub kit with function of a coaster brake. The hub kit with function of a coaster brake substantially comprises a hub body, a driving threaded rod extending into the hub body, an expending nut disposed in the hub body and connected to the driving threaded rod via a threaded engagement, and at least one brake pad disposed between an external surface of the expending nut and an internal peripheral surface of the hub body. When a rider reverses the pedals, the expending nut is driven to move along the driving threaded rod to push the at least one brake pad to move toward and tightly abut against the internal peripheral surface of the hub body to stop the hub body, thereby braking the bicycle.

It is very convenient to brake the bicycle with the hub kit with function of a coaster brake via reversing the pedals, but the hub kit with function of a coaster brake is broken easily and is unable to precisely control the strength of brake. So, the hub kit with function of a coaster brake is mostly assembled to a bicycle for acrobatics. If the rider would like to ride the bicycle for acrobatics in daily life, the hub kit with function of a coaster brake needs to be replaced with a hub kit without a coaster brake, and the spokes connected to the hub kit also need to be reconnected, which is time-consuming, laborious, and costly.

To overcome the shortcomings, the present invention provides a bicycle hub kit to mitigate or obviate the aforementioned problems.

### SUMMARY OF THE INVENTION

The present invention relates to a bicycle hub kit that has a replaceable sprocket to transform the bicycle hub kit to be with or without function of a coaster brake.

The bicycle hub kit comprises a shaft, a hub body, a driver, a connecting arm, a clutch sleeve, a braking base, at least one brake pad, and a sprocket. The hub body surrounds the shaft and has a first end and a second end. The driver surrounds the shaft, is disposed at the first end of the hub body, and has an outer end extending out of the hub body and an inner end extending into the hub body. The connecting arm is disposed at the second end of the hub body. The clutch sleeve surrounds the shaft, is able to move along the shaft, is disposed inside the hub body, and has a disengagement segment extending away from the driver and a braking segment adjacent to the driver, surrounding and connected with the inner end of the driver via a threaded engagement. An outer diameter of the braking segment is larger than an outer diameter of the disengagement segment. The braking base is fixed to and surrounds the shaft, extends into the second end of the hub body, and is located between the connecting arm and the clutch sleeve. The spring set is disposed between the braking base and the clutch sleeve. The at least one brake pad is disposed between an internal peripheral surface of the hub body and outer peripheries of the clutch sleeve and the braking base. The sprocket is connected to the outer end of the driver. Wherein, the sprocket is selected from the group consisting of a braking sprocket and a one-way sprocket. When the outer end of the driver is connected to the braking sprocket, the braking sprocket is configured to drive the driver to rotate forwardly and reversely, and the clutch sleeve is driven to move toward the braking base by a reverse rotation of the driver for pushing the at least one brake pad toward the internal peripheral surface of the hub body. When the outer end of the driver is connected to the one-way sprocket, the one-way sprocket is configured to drive the driver to rotate forwardly.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a bicycle hub kit in accordance with the present invention;

FIG. 2 is an exploded perspective view of the bicycle hub kit in FIG. 1;

FIG. 3 is a side view in partial section of the bicycle hub kit in FIG. 1 and shows a braking position;

FIG. 4 is another side view in partial section of the bicycle hub kit in FIG. 1 and shows the braking position;

FIG. 5 is a side view in partial section of the bicycle hub kit in FIG. 1 and shows a non-braking position;

FIG. 6 is a cross sectional side view of a driver of the bicycle hub kit in FIG. 3;

FIG. 7 is a perspective view of a brake pad of the bicycle hub kit in FIG. 3;

FIG. 8 is an end view of a fastening ring of the bicycle hub kit in FIG. 3;

FIG. 9 is an end view of a braking sprocket of the bicycle hub kit in FIG. 3;

FIG. 10 is a cross-sectional side view of the braking sprocket of the bicycle hub kit in FIG. 9;

FIG. 11 is a side view in partial section of a second embodiment of the bicycle hub kit in accordance with the present invention;

FIG. 12 is an end view of a one-way sprocket of the bicycle hub kit in FIG. 11; and

FIG. 13 is a side view in partial section of the one-way sprocket of the bicycle hub kit in FIG. 12.

### DETAILED DESCRIPTION OF PREFERRED EMBODIMENT

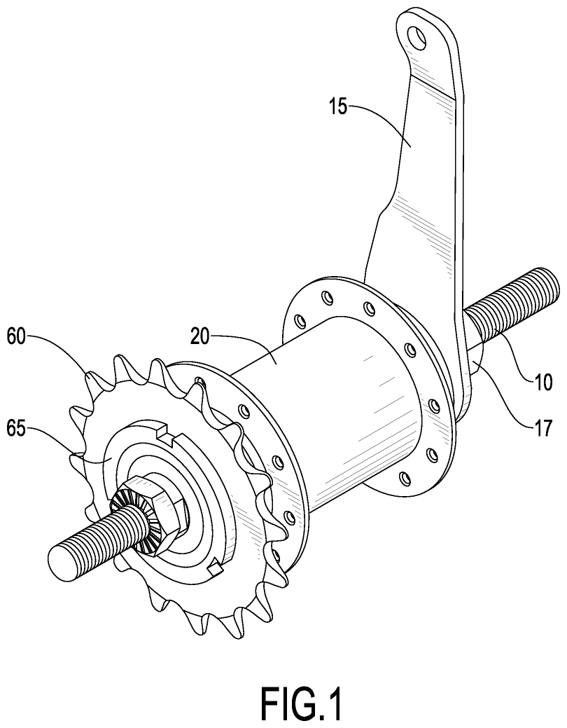

With reference to FIGS. 1 to 5, a first embodiment of a bicycle hub kit in accordance with the present invention comprises a shaft 10, a hub body 20, a driver 30, a connecting arm 15, a clutch sleeve 40, a spring set 45, a braking base 50, and at least one brake pad 55.

The hub body 20 surrounds the shaft 10 and has a first end and a second end opposite to each other. The driver 30 surrounds the shaft 10, is disposed at the first end of the hub body 20, and has an outer end extending out of the hub body 20 and an inner end extending into the hub body 20. The connecting arm 15 is disposed at the second end of the hub body 20. The connecting arm 15 is securely fixed to the braking base 50 via a hexagonal nut 17. The user can conveniently detach the hub body 20 with the connecting arm 15.

The clutch sleeve 40 surrounds the shaft 10 and is disposed inside the hub body 20 and is able to move along the shaft 10. The clutch sleeve 40 may be a single piece and comprises a disengagement segment 41 extending away from the driver 30 and a braking segment 42 adjacent to the driver 30, and surrounds and is connected with the inner end of the driver 30 via a threaded engagement. An outer diameter of the braking segment 42 is larger than an outer diameter of the disengagement segment 41. The braking segment 42 has a tapered surface facing toward the disengagement segment 41.

The braking base 50 is fixed to and surrounds the shaft 10, extends into the second end of the hub body 20, and is disposed between the connecting arm 15 and the clutch sleeve 40. The spring set 45 is disposed between the braking base 50 and the clutch sleeve 40. The at least one brake pad 55 is disposed between an internal peripheral surface of the hub body 20 and outer peripheries of the clutch sleeve 40 and the braking base 50.

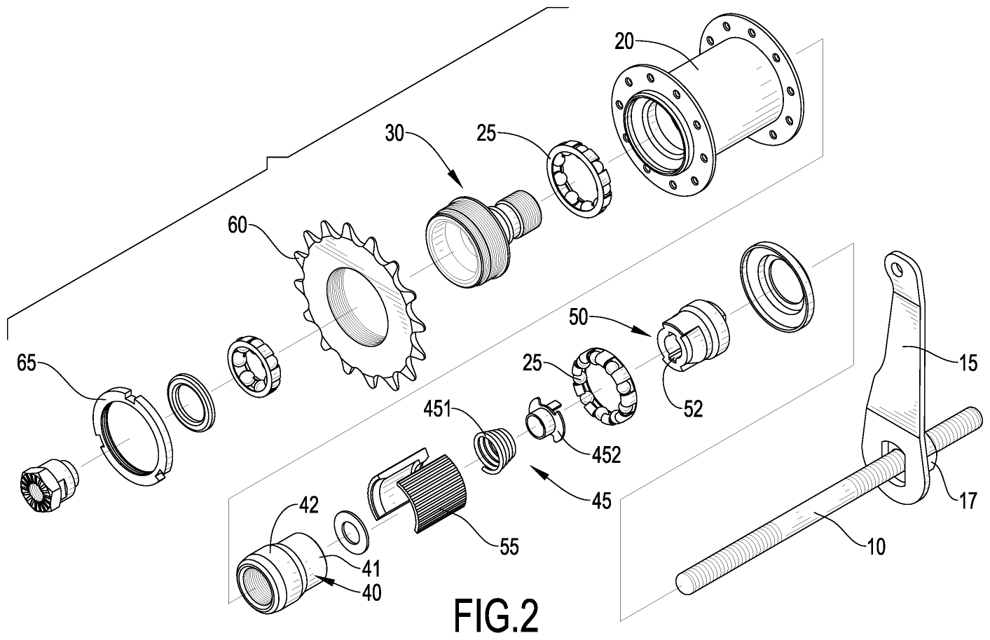

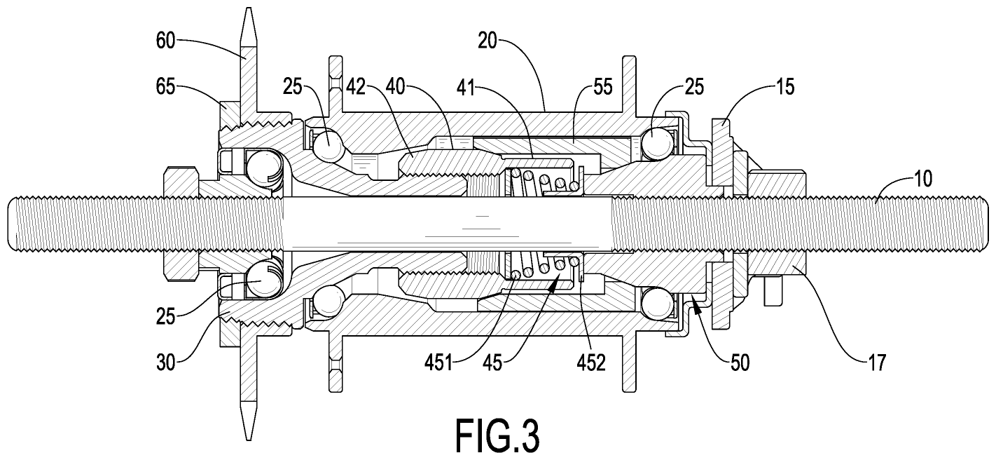

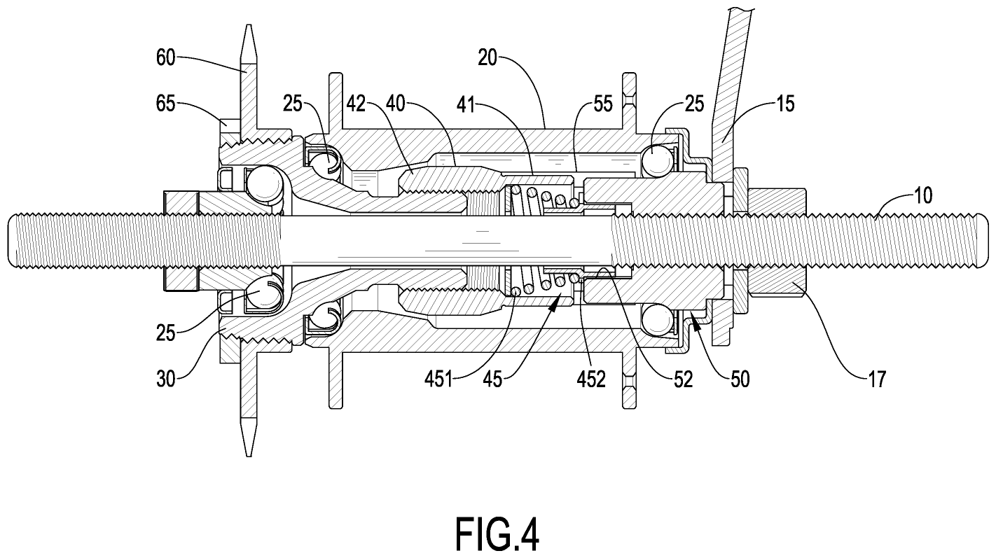

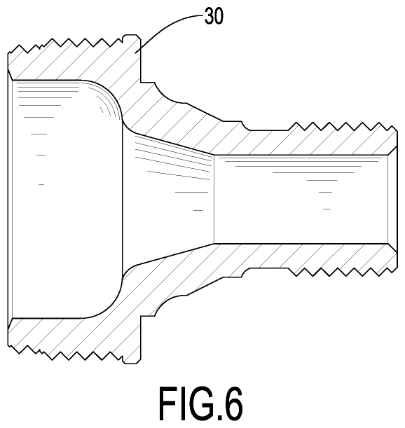

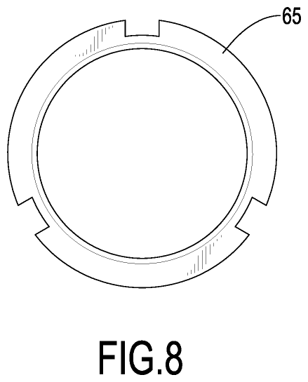

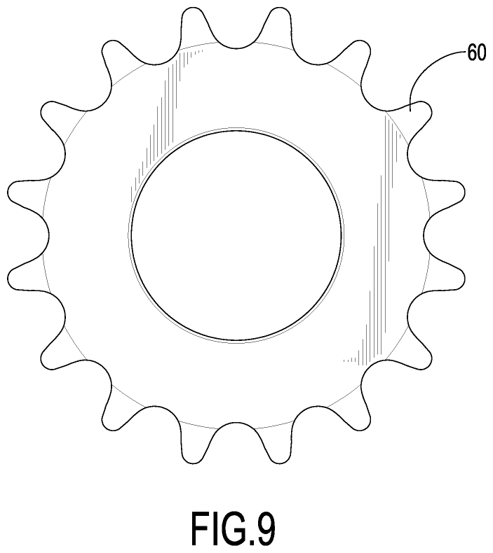

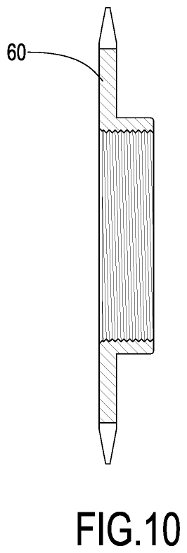

With reference to FIGS. 2 to 6 and 8 to 10, in the first embodiment, a braking sprocket 60 surrounds and is fixed to an outer end of the driver 30 extending out of the hub body 20. A thread may be spirally formed around an outer periphery of the outer end of the driver 30. The braking sprocket 60 may be connected to the driver 30 via a threaded engagement. So, the braking sprocket 60 can drive the driver 30 to rotate forwardly and reversely. A fastening ring 65 is disposed at an end of the braking sprocket 60 facing away from the hub body 20 and is connected to the driver 30 via a threaded engagement to fasten the braking sprocket 60. The braking sprocket 60 is fixed on the driver 30 in position via the fastening ring 65, but is not limited thereto. The braking sprocket 60 may be fixed to the driver 30 via any other configuration. With reference to FIGS. 3 and 4, when the pedals are stamped reversely, the braking sprocket 60 is driven by the pedals to drive the driver 30 to rotate reversely, and the clutch sleeve 40 is driven to move toward the braking base 50 by the driver 30 rotating reversely. The at least one brake pad 55 is pushed toward the internal peripheral surface of the hub body 20 by the braking segment 42 of the clutch sleeve 40 and friction the internal peripheral surface of the hub body 20 to slow down and brake the hub body 20.

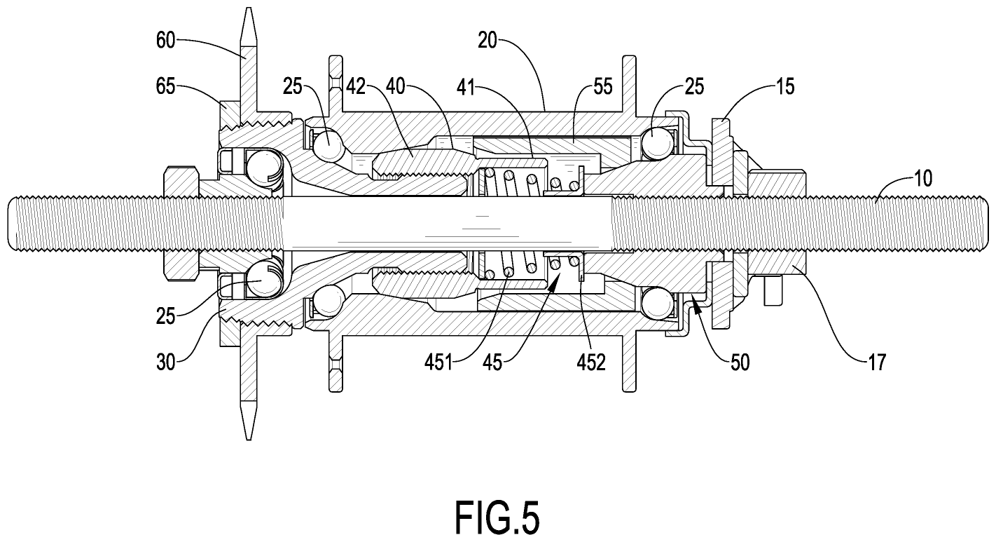

With reference to FIG. 5, since the outer diameter of the disengagement segment 41 is smaller than the outer diameter of the braking segment 42, when the pedals are pressed forwardly, the clutch sleeve 40 is located at a position as shown in FIG. 5, the disengagement segment 41 of the clutch sleeve 40 directly faces the at least one brake pad 55 without contacting the at least one brake pad 55. Accordingly, the hub body 20 can be driven normally. With reference to FIGS. 3 and 4, when the pedals are stamped reversely, the clutch sleeve 40 is driven to move backward by the driver 30. The braking segment 42 of the clutch sleeve 40 abuts against the at least one brake pad 55 and pushes the at least one brake pad 55 toward the hub body 20. The at least one brake pad 55 abuts against the internal peripheral surface of the hub body 20 to stop the hub body 20. In addition, an inner diameter of the disengagement segment 41 is larger than an inner diameter of the braking segment 42. The spring set 45 extends into the disengagement segment 41 and is kept from extending into the braking segment 42.

With reference to FIGS. 1 to 5, bearings 25 are configured for supporting or holding the braking base 50 and the driver 30, wherein one of the bearings 25 is disposed between the internal peripheral surface of the hub body 20 and the outer periphery of the braking base 50, another one of the bearings 25 is disposed between the internal peripheral surface of the hub body 20 and an outer periphery of the driver 30 at a middle thereof, and still another one of the bearings 25 is disposed within the outer end of the driver 30. Therefore, structural stability is enhanced and friction therebetween is reduced. The braking base 50 and the driver 30 can be rotated smoothly.

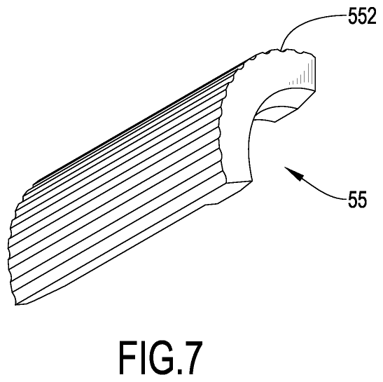

With reference to FIGS. 2, 3, and 7, each brake pad 55 is curved for fitting the outer peripheries of the clutch sleeve 40 and the braking base 50. Whereby, an assembling space can be reduced. Each brake pad 55 has a concave surface facing the outer peripheries of the clutch sleeve 40 and the braking base 50, a convex surface facing the internal surface of the hub body 20, and multiple grooves 552 formed in the convex surface at spaced intervals. Roughness at the convex surface of the brake pad 55 can be increased via the multiple grooves 552, and the friction between the brake pad 55 and the hub body 20 can be increased to improve the braking effect. The outer periphery of the braking base 50 has a tapered surface facing the clutch sleeve 40. Each brake pad 55 abuts against the tapered surface of the outer periphery of the braking base 50. The at least one brake pad 55 may include two said brake pads 55 disposed at diametrically opposite sides of the braking base 50 to enhance the braking effect.

With reference to FIGS. 2 to 4, the braking base 50 has a positioning groove 52 formed in an end of the braking base 50 facing toward the clutch sleeve 40. The spring set 45 includes a spring 451 and a positioning holder 452. The spring 451 extends into the disengagement segment 41. The positioning holder 452 is mounted to an end of the spring 451 facing away from the clutch sleeve 40 and extends into the positioning groove 52 of the braking base 50. When the braking sprocket 60 is rotated reversely, the clutch sleeve 40 is driven to move the tapered surface of the braking segment 42 of the clutch sleeve 40 to contact an inclined edge of the at least one brake pad 55. The at least one brake pad 55 is pushed to move toward and abut against the internal peripheral surface of the hub body 20 to brake the hub body 20.

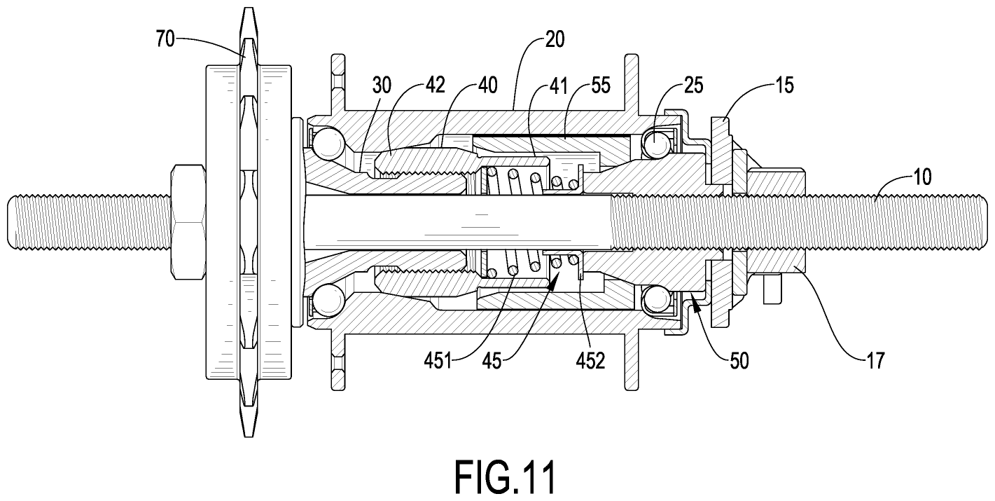

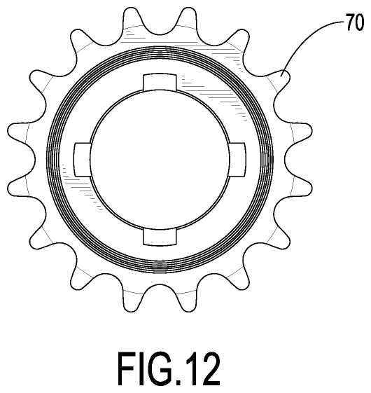

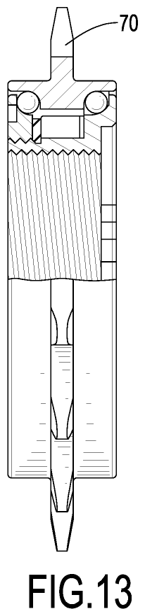

With reference to FIGS. 11 to 13, in the second embodiment, a one-way sprocket 70 is connected to the outer end of the driver 30 to drive the driver 30 to rotate forwardly. The one-way sprocket 70 includes an exterior ring, an interior ring connected to the driver 30, and a ratchet and pawl system disposed between the exterior ring and the interior ring. So the exterior ring can only drive the interior ring with the driver 30 to rotate forwardly and cannot drive the interior ring with the driver 30 to rotate reversely. When the pedals are stamped reversely, the exterior ring of the one-way sprocket 70 is driven to rotate reversely, and the driver 30 is static. Accordingly, if the braking sprocket 60 is replaced with the one-way sprocket 70, the bicycle hub kit in accordance with the present invention can be transformed from the bicycle hub kit with the function of a coaster brake to one without the function of a coaster brake.

If the function of a coater brake is needed, the braking sprocket 60 is connected to the outer end of the driver 30. The braking sprocket 60 is fixed to the driver 30 via the fastening ring 65. During the reverse rotation of the braking sprocket 60, the clutch sleeve 40 is driven by the driver 30 to move toward the braking base 50, the brake pad 55 is pushed toward the internal peripheral surface of the hub body 20 by the braking segment 42 of the clutch sleeve 40 and abuts against the internal peripheral surface of the hub body 20 to provide the braking effect. If function of the coater brake is not required, the braking sprocket 60 and the fastening ring 65 are removed, and the one-way sprocket 70 is connected to the outer end of the driver 30. During reversing of the pedals, the exterior ring of the one-way sprocket 70 is rotated reversely without driving the driver 30 to rotate, so the driver 30 is static. Accordingly, the braking sprocket 60 and the one-way sprocket 70 can be selectively assembled to the driver 30 to transform the bicycle hub kit to be with or without function of a coaster brake. The bicycle hub has a simple structure, is easy to use, and the user can easily replace the sprocket by himself/herself without reconnecting the bicycle hub kit to the spokes and wheel set, hereby saving time and labor and reducing maintenance costs.

What is claimed is:

1. A bicycle hub kit comprising:
a shaft;
a hub body surrounding the shaft and having a first end and a second end;
a driver surrounding the shaft, disposed at the first end of the hub body and having an outer end extending out of the hub body and an inner end extending into the hub body;
a connecting arm disposed at the second end of the hub body;
a clutch sleeve surrounding the shaft, being moveable along the shaft, disposed inside the hub body, and having a disengagement segment extending away from the driver and a braking segment adjacent to the driver, surrounding and connected with the inner end of the driver via a threaded engagement, and having an outer diameter being larger than an outer diameter of the disengagement segment;
a braking base fixed to and surrounding the shaft, extending into the second end of the hub body, and located between the connecting arm and the clutch sleeve;
a spring set disposed between the braking base and the clutch sleeve;
at least one brake pad disposed between an internal peripheral surface of the hub body, an outer periphery of the clutch sleeve, and an outer periphery of the braking base; and
a sprocket connected to the outer end of the driver, wherein
the sprocket is selected from the group consisting of a braking sprocket and a one-way sprocket;
when the outer end of the driver is connected to the braking sprocket, the braking sprocket is configured to drive the driver to rotate forwardly and reversely, the clutch sleeve is driven to move toward the braking base by a reverse rotation of the driver for pushing the at least one brake pad toward the internal peripheral surface of the hub body; and
when the outer end of the driver is connected to the one-way sprocket, the one-way sprocket is configured to drive the driver to rotate forwardly.

2. The bicycle hub kit as claimed in claim 1, wherein an inner diameter of the disengagement segment of the clutch sleeve is larger than an inner diameter of the braking segment of the clutch sleeve.

3. The bicycle hub kit as claimed in claim 1, wherein
a bearing is disposed between the internal peripheral surface of the hub body and the outer periphery of the braking base;
a bearing is disposed between the internal peripheral surface of the hub body and an outer periphery of the driver; and
a bearing is disposed within the outer end of the driver.

4. The bicycle hub kit as claimed in claim 3, wherein
the outer periphery of the braking base has a tapered surface facing the clutch sleeve;
each of the at least one brake pad is curved and has a convex surface, and multiple grooves recessed in the convex surface at spaced intervals; and
the at least one brake pad abuts the tapered surface of the outer periphery of the braking base.

5. The bicycle hub kit as claimed in claim 1, wherein
the braking base has a positioning groove formed in an end of the braking base facing the clutch sleeve;
the spring set includes a spring and a positioning holder;
the spring extends into the disengagement segment of the clutch sleeve;
the positioning holder is mounted to an end of the spring facing away from the clutch sleeve and extends into the positioning groove of the braking base.
